(19) United States
(12) Patent Application Publication
(10) Pub. No.: US 2026/0212711 A1
(43) Pub. Date: Jul. 23, 2026

(54) APPARATUS AND SYSTEM

(71) Applicant: TOYOTA JIDOSHA KABUSHIKI KAISHA, Toyota-shi (JP)

(72) Inventor: Teruyuki KANOU, Nagoya-shi (JP)

(73) Assignee: TOYOTA JIDOSHA KABUSHIKI KAISHA, Toyota-shi, Aichi-ken (JP)

(21) Appl. No.: 19/451,827

(22) Filed: Jan. 16, 2026

(30) Foreign Application Priority Data
Jan. 21, 2025 (JP) 2025-008548

(51) Int. Cl. G07C 5/00; G07C 5/10

(52) U.S. Cl. CPC G07C 5/008; G07C 5/10

(57) ABSTRACT

An apparatus includes a communication unit configured to communicate with a vehicle and a terminal apparatus used by a user of the vehicle, a memory storing history information on a history of an operation performed by the user on the vehicle at a predetermined timing, the history information being derived from vehicle information indicating a state of the vehicle, the vehicle information being acquired from the vehicle, and a processor configured to cause the terminal apparatus to present the history to the user by transmitting presenting information to the terminal apparatus of the user, the presenting information being information for presenting the history to the user.

### CROSS-REFERENCE TO RELATED APPLICATION

This application claims priority to Japanese Patent Application No. 2025-008548 filed on January 21, 2025. The disclosure of the above-identified application, including the specification, drawings, and claims, is incorporated by reference herein in its entirety.

### BACKGROUND

### 1. Technical Field

The disclosure relates to an apparatus and a system.

### 2. Description of Related Art

A technology for notifying a user in a vehicle of the status of various components of the vehicle, such as the open-closed state of doors, to prompt safety checks and the like is known. For example, Japanese Unexamined Patent Application Publication No. 2020-057140 (JP 2020-057140 A) describes a system that, when the closed state of rear seat doors of a vehicle is detected and then the start of vehicle movement is detected, provides a notification prompting a check of the rear seat when the end of vehicle movement is detected.

### SUMMARY

There is room for improvement in the reliability of avoiding forgetting to perform operations in a technology for avoiding forgotten operations, such as closing windows and locking doors, to be performed by users in vehicles.

The disclosure provides an apparatus and a system that improve the reliability of avoiding forgetting to perform an operation by a user of a vehicle.

A first aspect of the disclosure is an apparatus. The apparatus includes a communication unit configured to communicate with a vehicle and a terminal apparatus used by a user of the vehicle, a memory storing history information on a history of an operation performed by the user on the vehicle at a predetermined timing, the history information being derived from vehicle information indicating a state of the vehicle, the vehicle information being acquired from the vehicle, and a processor configured to cause the terminal apparatus to present the history to the user by transmitting presenting information to the terminal apparatus of the user, the presenting information being information for presenting the history to the user.

A second aspect of the disclosure is an apparatus. The apparatus includes a communication unit configured to communicate with a vehicle and a terminal apparatus used by a user of the vehicle, a memory storing history information on a history of an operation performed at a predetermined timing by the user on the vehicle, the history information being acquired from the vehicle, and a processor configured to transmit presenting information to the terminal apparatus of the user, the presenting information being information for presenting the history to the user.

In the second aspect, the processor may be configured to transmit prompting information for prompting the operation by the vehicle at the predetermined timing.

In the second aspect, the processor may be configured to transmit presenting information for presenting the history by the vehicle not at the predetermined timing.

In the second aspect, the processor may be configured to determine the predetermined timing based on acquiring information acquired from the vehicle.

In the second aspect, the history may include a history of each of a plurality of the operations at the predetermined timing.

In the second aspect, the history may include a history of the operation at each of a plurality of the predetermined timings.

A third aspect of the disclosure is a system. The system includes a vehicle, a terminal apparatus used by a user of the vehicle, and an apparatus configured to communicate with the vehicle and the terminal apparatus. The vehicle is configured to transmit history information on a history of an operation performed by the user on the vehicle at a predetermined timing to the apparatus. The apparatus is configured to transmit presenting information to the terminal apparatus, the presenting information being information for presenting the history to the user. The terminal apparatus is configured to output receiving information received from the apparatus.

In the third aspect, the apparatus may be configured to transmit prompting information for prompting the operation by the vehicle at the predetermined timing.

In the third aspect, the apparatus may be configured to transmit the presenting information by the vehicle not at the predetermined timing.

In the third aspect, the apparatus may be configured to determine the predetermined timing based on acquiring information acquired from the vehicle.

In the third aspect, the history may include a history of each of a plurality of the operations at the predetermined timing.

In the third aspect, the history may include a history of the operation at each of a plurality of the predetermined timings.

According to the first aspect, the second aspect, and the third aspect of the disclosure, it is possible to improve the reliability of avoiding forgetting to perform an operation by a user of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that shows a configuration example of an information processing system;

FIG. 2 is a diagram that shows an example of operation history information;

FIG. 3 is a flowchart that shows an example of the operation procedure of an information processing apparatus;

FIG. 4 is a flowchart that shows an example of the operation procedure of the information processing apparatus;

FIG. 5 is a view that shows display examples of a terminal apparatus; and

FIG. 6 is a view that shows display examples of the terminal apparatus.

### DETAILED DESCRIPTION OF EMBODIMENTS

Hereinafter, an embodiment will be described.

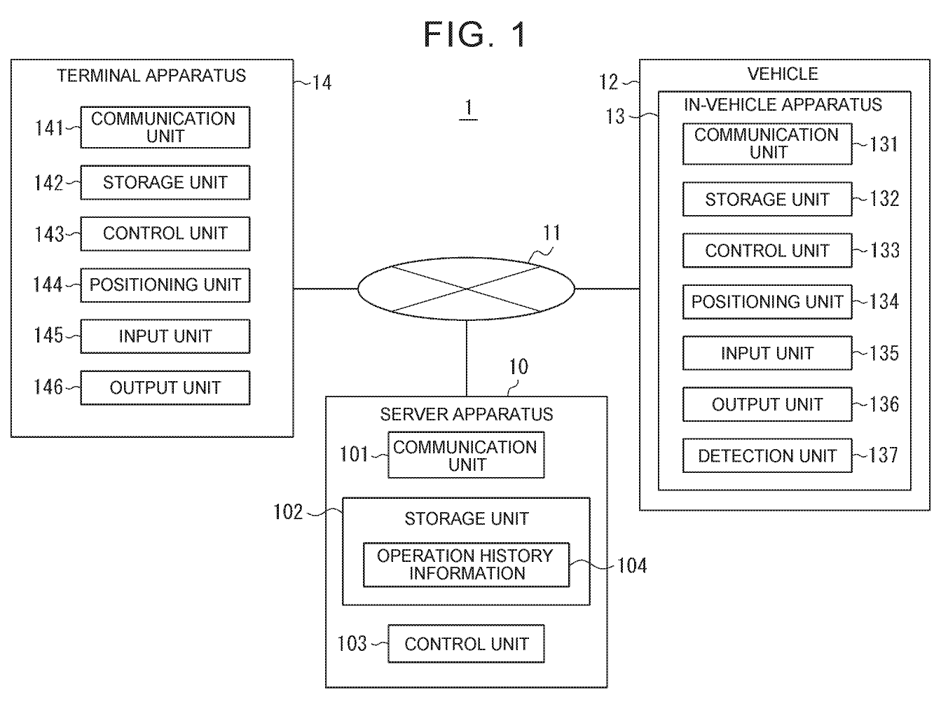

FIG. 1 is a diagram that shows an example of the configuration of an information processing system in an embodiment. The information processing system 1 includes one or more server apparatuses 10, one or more vehicles 12 and in-vehicle apparatuses 13 respectively mounted on the vehicles 12, and one or more terminal apparatuses 14, which are connected via a network 11 so as to be capable of communicating with each other. The server apparatus 10 is, for example, a server computer that belongs to a cloud computing system or another computing system and that functions as a server implementing various functions. The in-vehicle apparatus 13 is, for example, a navigation system having a communication function and an information processing function and is mounted on the vehicle 12. The vehicle 12 is a passenger vehicle, a commercial vehicle, or the like, and is a vehicle of which part or the whole of driving operation is performed manually by a driver. Examples of the vehicle 12 include a gasoline vehicle, a battery electric vehicle (BEV), a hybrid electric vehicle (HEV), a plug-in hybrid electric vehicle (PHEV), and a fuel cell electric vehicle (FCEV). The terminal apparatus 14 is an information processing terminal used by a user of the vehicle 12, such as a driver and a fellow passenger. Examples of the terminal apparatus 14 include a smartphone, a tablet terminal, and a personal computer (PC). The network 11 is, for example, the Internet and may be an ad hoc network, a LAN, a metropolitan area network (MAN), another network, or any combination of them.

The information processing system 1 of the present embodiment assists a user in avoiding forgetting to perform operations (hereinafter, referred to as set operations) set to be performed by a user at a predetermined timing (hereinafter, referred to as reference timing), such as immediately after the start of movement of the vehicle 12 and after a stop of the vehicle 12. Specifically, the server apparatus 10 that serves as an "information processing apparatus" in the present embodiment includes a communication unit 101, a storage unit 102, and a control unit 103 with the following functions. The communication unit 101 communicates with the vehicle 12 and the terminal apparatus 14 used by the user of the vehicle 12. The storage unit 102 stores information (hereinafter, referred to as operation history information) 104 on the history of operations (hereinafter, referred to as operation history) performed by the user on the vehicle 12 at the reference timing, the operation history information being acquired from the vehicle 12. Then, the control unit 103 transmits, to the terminal apparatus 14 of the user, information (hereinafter, referred to as presentation information) for presenting the operation history to the user. As a result, the operation history is, for example, displayed on the terminal apparatus 14, and the user is able to check the operation history, that is, whether the set operations have been performed. Thus, the user is able to understand his or her own behavioral tendency, such as a tendency to forget set operations and a tendency to reliably perform set operations. Therefore, when the user has a tendency to forget set operations, the user is able to recognize the tendency and cultivate an awareness of not forgetting set operations. In other words, it is possible to improve the reliability of avoiding forgetting to perform set operations performed by the user of the vehicle.

Next, an example of the configuration of the server apparatus 10 will be described.

The server apparatus 10 includes a communication unit 101, a storage unit 102, and a control unit 103. The server apparatus 10 may be a single computer or may be made up of two or more computers that are connected to each other so as to be capable of communicating and that operate in cooperation with each other. When the server apparatus 10 is made up of two or more computers, the configuration shown in FIG. 1 is arranged among the two or more computers as needed.

The communication unit 101 includes one or more communication interfaces. The communication interface is, for example, a LAN interface. The communication unit 101 receives information used in the operation of the control unit 103 and transmits information obtained through the operation of the control unit 103. The server apparatus 10 is connected to the network 11 by the communication unit 101 and communicates with the in-vehicle apparatus 13 and the terminal apparatus 14 via the network 11.

The storage unit 102 includes, for example, one or more semiconductor memories, one or more magnetic memories, one or more optical memories, or a combination of at least two types of them, that function as a main storage device, an auxiliary storage device, or a cache memory. The semiconductor memory is, for example, a random access memory (RAM) or a read only memory (ROM). The RAM is, for example, a static RAM (SRAM) or a dynamic RAM (DRAM). The ROM is, for example, an electrically erasable programmable ROM (EEPROM). The storage unit 102 stores information used in the operation of the control unit 103 and information obtained through the operation of the control unit 103.

The control unit 103 includes one or more processors, one or more dedicated circuits, or a combination of them. The processor is, for example, a general-purpose processor, such as a central processing unit (CPU), or a special-purpose processor, such as a graphics processing unit (GPU), specialized in a specific process. The dedicated circuit is, for example, a field-programmable gate array (FPGA) or an application specific integrated circuit (ASIC). The control unit 103 executes information processing related to the operation of the server apparatus 10 while controlling the units of the server apparatus 10.

The functions of the server apparatus 10 are implemented by the processor of the control unit 103, running a control program. The control program is a program for causing a computer to execute processes of steps included in the operation of the server apparatus 10 to cause the computer to implement functions corresponding to the processes of steps. In other words, the control program is a program for causing a computer to function as the server apparatus 10. One or some or all of the functions of the server apparatus 10 may be implemented by a dedicated circuit included in the control unit 103. The control program may be stored in a non-transitory recording and storage medium readable by the server apparatus 10, and the server apparatus 10 may read the control program from the medium.

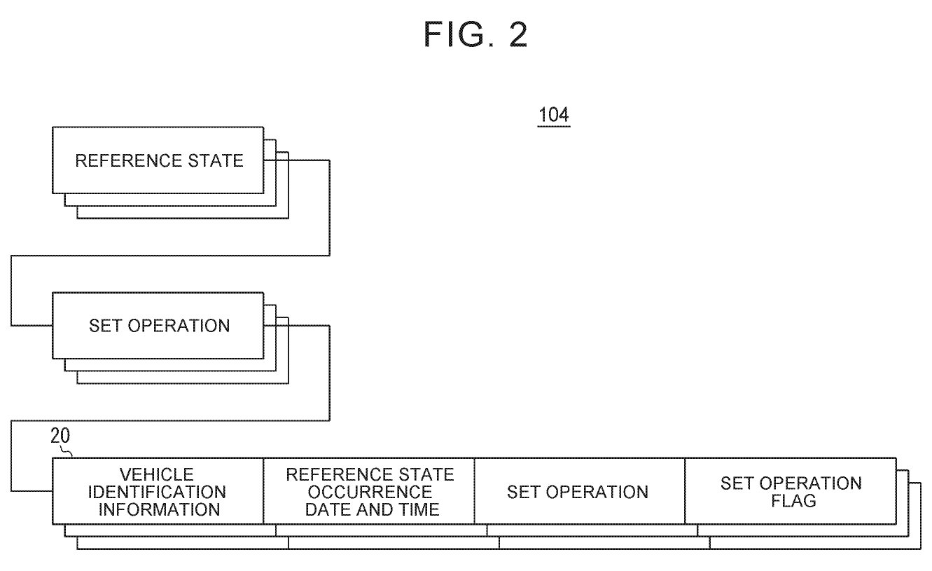

In the present embodiment, the storage unit 102 stores the operation history information 104. The operation history information 104, as schematically shown in FIG. 2, includes information on one or more reference states and information on one or more set operations corresponding to each of the reference states. The reference states are the states of the vehicle 12, respectively corresponding to triggers for set operations, that is, reference timings, and are, for example, the start or stop of an engine, whether a vehicle speed is zero, and whether a current location has been moved. Alternatively, the reference states may include the arrival of selected time when the probability that the vehicle 12 is moving or stopped is high. Set operations are operations to be performed by the user for each reference state. For example, set operations such as wearing a seatbelt, unfolding side mirrors, and turning on lights at night are associated with the reference states that indicate immediately after the start of movement of the vehicle 12 such as the start of the engine, the vehicle speed higher than zero, the movement of the current location, and the arrival of time to move. Set operations such as closing the windows, activating parking brake, and locking the doors are associated with the reference states indicating immediately after the end of movement of the vehicle 12 such as the stop of the engine, the reduction of the vehicle speed, the end of movement of the current location, and the arrival of time to stop. The operation history information 104 has one or more operation histories 20 corresponding to each of the set operations. The operation history 20 contains information called a set operation flag indicating whether a set operation was performed for each combination of vehicle identification information, reference state, occurrence date and time of the reference state, and set operation for each vehicle 12.

Referring back to FIG. 1, an example of the configuration of the in-vehicle apparatus 13 will be described.

The in-vehicle apparatus 13 includes a communication unit 131, a storage unit 132, a control unit 133, a positioning unit 134, an input unit 135, an output unit 136, and a detection unit 137. These units may be made up of a single controller, or may be made up of two or more controllers, or may be made up of a controller and another device, such as a communication instrument. The controller includes, for example, an electronic control unit (ECU). The communication instrument includes, for example, a data communication module (DCM). The units are connected to each other or to various devices of the vehicle 12 via an in-vehicle network that conforms to standards, such as a controller area network (CAN), so as to be capable of communicating with the various devices. The in-vehicle apparatus 13 may be configured to partially include a device equivalent to the terminal apparatus 14.

The communication unit 131 includes a communication module that supports wired or wireless LAN standards, a module that supports mobile communication standards such as Long Term Evolution (LTE), 4th Generation (4G), and 5th Generation (5G), and the like. The in-vehicle apparatus 13 is connected to the network 11 via a nearby router device or mobile communication base station by the communication unit 131 and communicates with another apparatus via the network 11.

The storage unit 132 includes one or more semiconductor memories, one or more magnetic memories, one or more optical memories, or a combination of at least two types of them. The semiconductor memory is, for example, a RAM or a ROM. The RAM is, for example, an SRAM or a DRAM. The ROM is, for example, an EEPROM. The storage unit 132 functions as, for example, a main storage device, an auxiliary storage device, or a cache memory. The storage unit 132 stores information used in the operation of the control unit 133 and information obtained through the operation of the control unit 133.

The control unit 133 includes one or more processors, one or more dedicated circuits, or a combination of them. The processor is a general-purpose processor, such as a CPU, or a special-purpose processor, such as a GPU, specialized in a specific process. The dedicated circuit is, for example, an FPGA or an ASIC. The control unit 133 executes information processing related to the operation of the in-vehicle apparatus 13 while controlling the units of the in-vehicle apparatus 13.

The functions of the control unit 133, such as navigation and multimedia playback, are implemented by the processor included in the control unit 133, running a control and processing program. The control and processing program is a program for causing a computer to execute processes of steps included in the operation of the control unit 133 to cause the computer to implement functions corresponding to the processes of steps. In other words, the control and processing program is a program for causing a computer to function as the control unit 133. One or some or all of the functions of the control unit 133 may be implemented by the dedicated circuit included in the control unit 133.

The positioning unit 134 includes one or more global navigation satellite system (GNSS) receivers. The GNSS includes, for example, any one of Global Positioning System (GPS), Quasi-Zenith Satellite System (QZSS), BeiDou, Global Navigation Satellite System (GLONASS), and Galileo. The positioning unit 134 transmits the positioning results to the control unit 133, and the location information of the in-vehicle apparatus 13, that is, the vehicle 12, is obtained in the control unit 133.

The input unit 135 includes one or more input interfaces. The input interface is, for example, a microphone that receives voice input, a physical key, a capacitance key, a pointing device, or a touch screen provided integrally with a display. The input interface is provided in the vehicle 12 and includes an interface with a camera that captures images of the interior or exterior of the vehicle 12. The camera may be built into the in-vehicle apparatus 13 or may be separate from the in-vehicle apparatus 13. The input unit 135 receives an operation, voice, or an image of the driver or the like, captured by the camera, by which the user, such as the driver, inputs information used in the operation of the control unit 133, and transmits the received information to the control unit 133.

The output unit 136 includes one or more output interfaces. The output interface is, for example, a speaker that outputs sound or a display that outputs images. The display is, for example, a liquid crystal display (LCD) or an organic electro-luminescence (EL) display. The output unit 136 outputs information obtained through the operation of the control unit 133.

The detection unit 137 includes sensors that detect various events occurring in the vehicle 12 or an interface with sensors. The sensors include, for example, sensors that detect the motion state of the vehicle 12, such as the speed, longitudinal acceleration, lateral acceleration, and deceleration of the vehicle 12, and sensors that detect an accelerator operation amount, a brake operation amount, a steering angle, the duration of turn signal, the on/off status of headlights, the opening and closing operations of the windows and doors, locking and unlocking, and a seatbelt usage status. The sensors include sensors that detect a fuel consumption per unit time, an eco mode selection status, an odometer value, information on the activation of safety equipment, the remaining level of engine oil or the like, brake pad wear level, the degree of battery degradation, and the like. Furthermore, the sensors include millimeter-wave, infrared, or another radar that detect targets around the vehicle 12. The detection unit 137 transmits vehicle information indicating various states of the vehicle 12, detected by the sensors, to the control unit 133.

The control unit 133 controls the communication unit 131, the storage unit 132, the positioning unit 134, the input unit 135, the output unit 136, and the detection unit 137 while exchanging various pieces of information with these units, and controls the operation of the vehicle 12. While the vehicle 12 is moving, the control unit 133 provides navigation functions by presenting various pieces of information, such as route information used for driving, to the driver via the output unit 136, and controls partial autonomous driving of the vehicle 12.

Next, an example of the configuration of the terminal apparatus 14 will be described.

The terminal apparatus 14 includes a communication unit 141, a storage unit 142, a control unit 143, a positioning unit 144, an input unit 145, and an output unit 146.

The communication unit 141 includes a communication module that supports wired or wireless LAN standards, a module that supports mobile communication standards such as LTE, 4G, and 5G, and the like. The terminal apparatus 14 is connected to the network 11 via a nearby router device or mobile communication base station by the communication unit 141 and communicates with another apparatus via the network 11.

The storage unit 142 includes one or more semiconductor memories, one or more magnetic memories, one or more optical memories, or a combination of at least two types of them. The semiconductor memory is, for example, a RAM or a ROM. The RAM is, for example, an SRAM or a DRAM. The ROM is, for example, an EEPROM. The storage unit 142 functions as, for example, a main storage device, an auxiliary storage device, or a cache memory. The storage unit 142 stores information used in the operation of the control unit 143 and information obtained through the operation of the control unit 143.

The control unit 143 includes one or more processors, one or more dedicated circuits, or a combination of them. The processor is a general-purpose processor, such as a CPU, or a special-purpose processor, such as a GPU, specialized in a specific process. The dedicated circuit is, for example, an FPGA or an ASIC. The control unit 143 executes information processing related to the operation of the terminal apparatus 14 while controlling the units of the terminal apparatus 14.

The positioning unit 144 includes one or more GNSS receivers. The GNSS includes, for example, any one of GPS, QZSS, BeiDou, GLONASS, and Galileo. The positioning unit 144 transmits the positioning results to the control unit 143, and the location information of the terminal apparatus 14 is obtained in the control unit 143.

The input unit 145 includes one or more input interfaces. The input interface is, for example, a microphone that receives voice input, a physical key, a capacitance key, a pointing device, a touch screen provided integrally with a display, or a camera that captures images. The input unit 145 receives operation to input information used in the operation of the control unit 143 and transmits the input information to the control unit 143.

The output unit 146 includes one or more output interfaces. The output interface is, for example, a speaker or a display. The display is, for example, an LCD or an organic EL display. The output unit 146 outputs information obtained through the operation of the control unit 143.

The functions of the control unit 143 are implemented by the processor of the control unit 143, running the control and processing program. The control and processing program is a program for causing a computer to execute processes of steps included in the operation of the control unit 143 to cause the computer to implement functions corresponding to the processes of steps. In other words, the control and processing program is a program for causing a computer to function as the control unit 143. One or some or all of the functions of the control unit 143 may be implemented by the dedicated circuit included in the control unit 143.

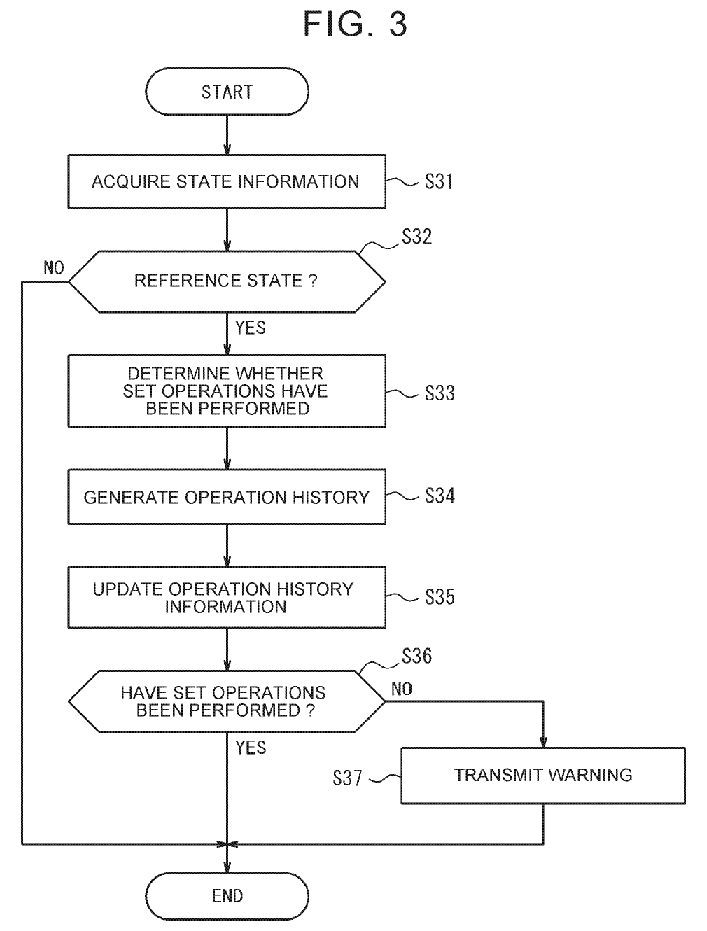

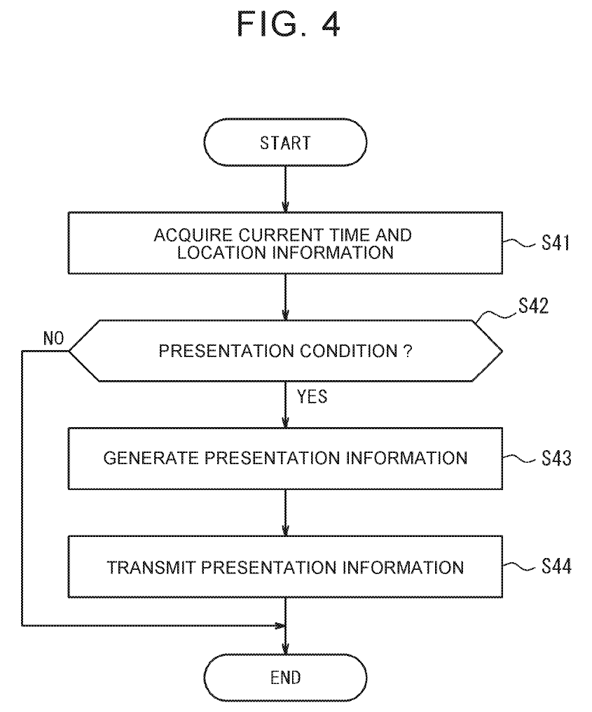

FIGS. 3 and FIG. 4 are flowcharts that illustrate examples of the operation of the server apparatus 10 in the overall operation of the information processing system 1. Each step in FIGS. 3 and FIG. 4 is executed by the control unit 103 of the server apparatus 10.

The example of the procedure in FIG. 3 is an example of the procedure when the operation history information 104 is stored in the server apparatus 10. The example of the procedure is repeatedly executed by the control unit 103 at intervals of, for example, one to several seconds during the period from the establishment of communication between the in-vehicle apparatus 13 and the server apparatus 10 until the communication between the in-vehicle apparatus 13 and the server apparatus 10 is disconnected. When the server apparatus 10 communicates with the in-vehicle apparatuses 13 of a plurality of vehicles 12, the procedure of FIG. 3 is executed for each in-vehicle apparatus 13.

In S31, the control unit 103 of the server apparatus 10 acquires state information. The state information is information indicating the state of the vehicle 12, including, for example, the driving state of the engine, vehicle speed, acceleration, and current location of the vehicle 12. The state information is accompanied by the identification information of each vehicle 12 along with the timestamp at the time of detection. In the in-vehicle apparatus 13, the control unit 133 transmits the prestored identification information of the vehicle 12 along with the detection results from the detection unit 137 to the server apparatus 10 via the communication unit 131, and the information from the in-vehicle apparatus 13 is received by the server apparatus 10. The control unit 103 acquires state information from the information transmitted from the in-vehicle apparatus 13.

In step S32, the control unit 103 determines whether any reference state has occurred. The control unit 103 determines whether the reference state has occurred, such as the start or stop of the engine, whether the vehicle speed is zero, and whether the current location has been moved, based on the state information. Alternatively, the control unit 103 may determine the arrival of time to move or the arrival of time to stop based on the current time. When the control unit 103 determines that the reference state has occurred (Yes in S32), the control unit 103 proceeds to S33; whereas, when the control unit 103 determines that the reference state has not occurred (No in S32), the control unit 103 ends one cycle of the procedure of FIG. 3. When the reference state has occurred, the control unit 103 derives the occurrence date and time of the reference state based on the timestamp of the state information used for determining whether the reference state has occurred.

In S33, the control unit 103 determines whether the set operations have been performed. The control unit 103 consults the operation history information 104, identifies one or more set operations corresponding to the reference state, and determines whether the identified set operations have been performed. The control unit 103 requests that the in-vehicle apparatus 13 provide detection information on operations performed by the user to acquire the detection information on operations from the in-vehicle apparatus 13. In the in-vehicle apparatus 13, detection information on operations is acquired by the detection unit 137 and is transmitted to the server apparatus 10. The control unit 103 can determine whether set operations, such as using the seatbelt, unfolding the side mirrors, turning on the lights, closing the windows, activating the parking brake, and locking the doors, have been performed, by searching the detection information for information indicating that the set operations have been performed. When the current time is during nighttime, for example, in a time period from 17:00 to 6:00, the control unit 103 can determine whether the lights have been turned on as a set operation.

In S34, the control unit 103 generates a new operation history 20. The control unit 103 generates a combination of the identification information of the vehicle 12, the type of the reference state, the occurrence date and time of the reference state, the type of a set operation, and a set operation flag as a new operation history 20.

In S35, the control unit 103 updates the operation history information 104. The control unit 103 updates the operation history information 104 by adding the new operation history 20.

In S36, the control unit 103 determines whether the set operations have been performed based on the determination result in S33. When the set operations have been performed (Yes in S36), the control unit 103 ends one cycle of the procedure of FIG. 3 and proceeds to S33; whereas, when the set operations have not been performed (No in S36), the control unit 103 proceeds to S37.

In S37, the control unit 103 transmits a warning. A warning is information of a statement or sound indicating that the set operations have not been performed. The control unit 103 transmits a warning to the in-vehicle apparatus 13 or the terminal apparatus 14 of the user to cause the in-vehicle apparatus 13 or the terminal apparatus 14 to output the warning. By doing so, it is possible to immediately make the user recognize any forgotten set operations. Then, the control unit 103 ends the procedure of FIG. 3.

The case where S36 and S37 are omitted are also included in the present embodiment.

The example of the procedure in FIG. 4 is an example of the procedure when presentation information is generated and output in the server apparatus 10. The example of the procedure is repeatedly executed by the control unit 103 at selected intervals, for example, at intervals of several seconds to several tens of seconds. When the server apparatus 10 communicates with a plurality of terminal apparatuses 14, the procedure of FIG. 4 is executed for each terminal apparatus 14.

In step S41, the control unit 103 acquires the current time and the location information of the terminal apparatus 14. In the terminal apparatus 14, when the control unit 143 acquires the location information via the positioning unit 144 and transmits the location information to the server apparatus 10, information from the terminal apparatus 14 is received by the server apparatus 10. The control unit 103 acquires information on the current time along with the location information of the terminal apparatus 14.

In step S42, the control unit 103 determines whether a presentation condition is satisfied. The presentation condition is a condition for transmitting presentation information to the terminal apparatus 14. The presentation condition is, for example, a condition that a time period during which there is a low probability that the user moves by the vehicle 12 has come, or the terminal apparatus 14, that is, the position of the user, is in a place where there is a low probability that the position of the user is moving, such as the location of the user is indoors. The time period during which there is a low probability that the user moves by the vehicle 12 may be, for example, a time period from late night to early morning, such as from midnight to 5 AM, or may be a specific time period during which no movement is planned, identified by acquiring schedule information of the user from another server. The control unit 103 can determine whether the current time or the position of the terminal apparatus 14 matches the presentation condition, by consulting information of the presentation condition stored in the storage unit 102 in advance. When the control unit 103 determines that the presentation condition is satisfied (Yes in S42), the control unit 103 proceeds to step S43; whereas, when the control unit 103 determines that the presentation condition is not satisfied (No in S42), the control unit 103 ends one cycle of the procedure of FIG. 4.

In S43, the control unit 103 generates presentation information. The presentation information is information for outputting information, in the form of text, images, or sound, as to whether the set operations have been performed on the vehicle 12 by the user of the terminal apparatus 14. The control unit 103 identifies the user of the terminal apparatus 14 and identifies the vehicle 12 of the user by using information that associates the identification information of the vehicle 12, the identification information of the user of the vehicle 12, and the identification information of the terminal apparatus 14, stored in the server apparatus 10 in advance. Then, the control unit 103 generates presentation information by extracting the operation history 20 from the operation history information 104 based on the identification information of the identified vehicle 12. The control unit 103 can generate presentation information by extracting the operation history 20 for a selected period, for example, the past few days to the past several months. The presentation information includes information, such as the occurrence date and time of the reference state for each reference state over a selected period, the types of the set operations, and whether the set operations have been performed.

In S44, the control unit 103 transmits the presentation information. The control unit 103 transmits the presentation information to the terminal apparatus 14. Then, the control unit 103 ends the procedure of FIG. 4.

Upon receiving the presentation information, the terminal apparatus 14 displays the presentation information or outputs sound in addition to the display, to present the presentation information to the user. By doing so, it is possible for the user to cultivate an awareness of not forgetting set operations, and it is possible to improve the reliability of avoiding forgetting to perform set operations.

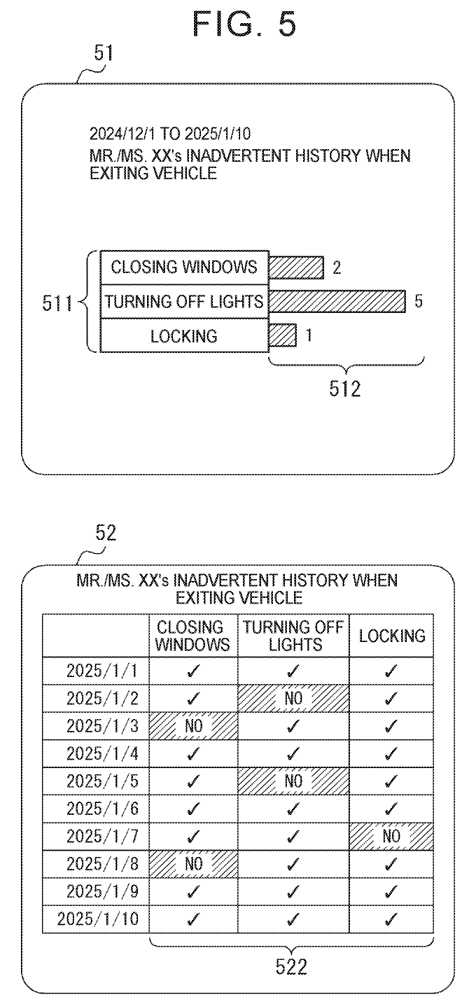

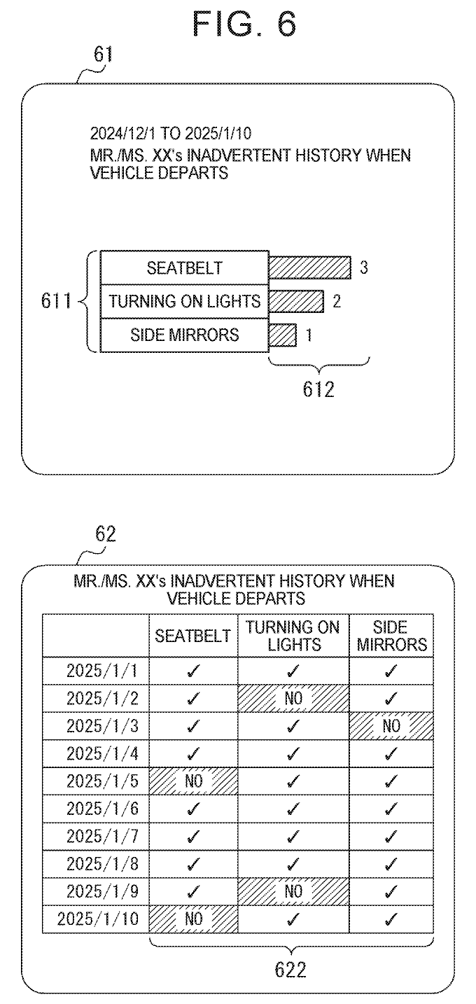

FIGS. 5 and FIG. 6 are output examples of the presentation information in the terminal apparatus 14.

FIG. 5 shows schematic display screens 51, 52 by the terminal apparatus 14. The display screens 51, 52 show a situation of forgetting set operations “when exiting the vehicle 12”, which corresponds to a reference state indicating immediately after the stop of the vehicle 12, such as the stop of the engine, the reduction of the vehicle speed, the end of movement of the current location, and the arrival of time to stop. For example, the display screen 51 shows set operation items 511 for “when exiting the vehicle 12” in the period “from 2024/12/1 to 2025/1/10”. The items 511 are, for example, “closing the windows”, “turning off the lights”, and “locking”. The display screen 51 further contains a graph 512 for the number of times a set operation was not performed for each set operation. The display screen 52 contains a history table 522 that shows that a set operation was performed or not performed for each set operation “when exiting the vehicle 12”. The history table 522 shows check marks for performed states and shows "NO" for non-performed states in temporal sequence.

FIG. 6 shows schematic display screens 61, 62 by the terminal apparatus 14. The display screens 61, 62 show a situation of forgetting set operations “when the vehicle 12 departs”, which corresponds to a reference state indicating immediately after the start of movement of the vehicle 12, such as the start of the engine, the increase of the vehicle speed, the start of movement of the current location, and the arrival of time to move. For example, the display screen 61 shows set operation items 611 for “when the vehicle 12 departs” in the period “from 2024/12/1 to 2025/1/10”. The items 611 include, for example, “(fastening of) the seatbelt”, “turning on the lights”, and “(unfolding) the side mirrors”. The display screen 61 further contains a graph 612 for the number of times a set operation was not performed for each set operation. The display screen 62 contains a history table 622 that shows that a set operation was performed or not performed for each set operation “when the vehicle 12 departs”. The history table 622 shows check marks for performed states and shows "NO" for non-performed states in temporal sequence.

The display screens 51, 52 in FIG. 5 and the display screens 61, 62 in FIG. 6 can be switched as needed between each other depending on user’s operation or two or more screens can be simultaneously shown in the terminal apparatus 14. In addition to such display examples, the control unit 143 of the terminal apparatus 14 can also output the number of times a set operation was not performed for each set operation item, the dates and times at which a set operation was not performed by sound for each set operation, or the like.

By receiving the presentation of the presentation information as described above, the user can more intuitively recognize his or her tendency to forget set operations. Therefore, it is possible to improve the reliability of avoiding forgetting to perform set operations by the user of the vehicle.

In the above-described embodiment, a processing and control program that defines the operations of the in-vehicle apparatus 13 and terminal apparatus 14 may be stored in the storage unit 102 of the server apparatus 10 or a storage unit of another server apparatus and downloaded to the in-vehicle apparatus 13 and the terminal apparatus 14 via the network 11, or may be stored in a non-transitory recording and storage medium readable by the in-vehicle apparatus 13 and the terminal apparatus 14 and may be read from the medium by the in-vehicle apparatus 13 and the terminal apparatus 14.

The embodiment has been described based on the drawings and the examples; however, it should be noted that various modifications and alterations can be easily made based on the disclosure by persons skilled in the art. Therefore, it should be noted that the scope of the disclosure encompasses these modifications and alterations. For example, the functions, and the like, included in the devices, steps, or other components, may be rearranged without any logical contradiction, and a plurality of devices, steps, or other components, may be combined as one or may be divided.

What is claimed is:

1. An apparatus comprising:
a communication unit configured to communicate with a vehicle and a terminal apparatus used by a user of the vehicle;
a memory storing history information on a history of an operation performed by the user on the vehicle at a predetermined timing, the history information being derived from vehicle information indicating a state of the vehicle, the vehicle information being acquired from the vehicle; and
a processor configured to cause the terminal apparatus to present the history to the user by transmitting presenting information to the terminal apparatus of the user, the presenting information being information for presenting the history to the user.

2. An apparatus comprising:
a communication unit configured to communicate with a vehicle and a terminal apparatus used by a user of the vehicle;
a memory storing history information on a history of an operation performed at a predetermined timing by the user on the vehicle, the history information being acquired from the vehicle; and
a processor configured to transmit presenting information to the terminal apparatus of the user, the presenting information being information for presenting the history to the user.

3. The apparatus according to claim 2, wherein the processor is configured to transmit prompting information for prompting the operation by the vehicle at the predetermined timing.

4. The apparatus according to claim 2, wherein the processor is configured to transmit presenting information for presenting the history by the vehicle not at the predetermined timing.

5. The apparatus according to claim 2, wherein the processor is configured to determine the predetermined timing based on acquiring information acquired from the vehicle.

6. The apparatus according to claim 2, wherein the history includes a history of each of a plurality of the operations at the predetermined timing.

7. The apparatus according to claim 2, wherein the history includes a history of the operation at each of a plurality of the predetermined timings.

8. A system comprising:
a vehicle;
a terminal apparatus used by a user of the vehicle; and
an apparatus configured to communicate with the vehicle and the terminal apparatus, wherein
the vehicle is configured to transmit history information on a history of an operation performed by the user on the vehicle at a predetermined timing to the apparatus,
the apparatus is configured to transmit presenting information to the terminal apparatus, the presenting information being information for presenting the history to the user, and
the terminal apparatus is configured to output receiving information received from the apparatus.

9. The system according to claim 8, wherein the apparatus is configured to transmit prompting information for prompting the operation by the vehicle at the predetermined timing.

10. The system according to claim 8, wherein the apparatus is configured to transmit the presenting information by the vehicle not at the predetermined timing.

11. The system according to claim 8, wherein the apparatus is configured to determine the predetermined timing based on acquiring information acquired from the vehicle.

12. The system according to claim 8, wherein the history includes a history of each of a plurality of the operations at the predetermined timing.

13. The system according to claim 8, wherein the history includes a history of the operation at each of a plurality of the predetermined timings.
